(19) United States
(12) Patent Application Publication
(10) Pub. No.: US 2018/0158005 A1
(43) Pub. Date: Jun. 7, 2018

(54) COMPUTER IMPLEMENTED METHODS AND SYSTEMS FOR MANAGING TASKS

(71) Applicant: Gennady BATRAKOV, Santa Clara, CA (US)

(72) Inventor: Gennady BATRAKOV, Santa Clara, CA (US)

(21) Appl. No.: 15/808,896

(22) Filed: Nov. 10, 2017

Related U.S. Application Data
(60) Provisional application No. 62/430,352, filed on Dec. 6, 2016.

(51) Int. Cl. G06Q 10/06

(52) U.S. Cl. CPC G06Q 10/06311

(57) ABSTRACT

A computer-implemented method and a system for managing tasks are provided. The method includes receiving a task input, by a processor, where the task input includes a task from among a plurality of tasks. The task input is provided by an administrator. The processor receives a time frame for the task, where the time frame includes a start time and an end time. The method further includes receiving a responsibility area associated with the task, by the processor. The processor receives an effort point input associated with the task, where the effort point is associated with an effort needed to complete the task. The processor facilitates display of the task in a digital platform with one or more representations of the responsibility area, the time frame and the effort. The representations are at least one of a color, a shape, and size of the shape.

### TECHNICAL FIELD

Embodiments of the disclosure relate generally to computer implemented techniques for management of time and tasks.

### BACKGROUND

Typically, projects and group activities involve several tasks. The sequence of tasks must be planned based on the available resources and monitored continuously such that the tasks can be accomplished within optimized time with expected yield in productivity.

Task management is typically the process of managing a task through its life cycle. A task can be as small as managing a list of grocery items or a list of meetings to attend. Further, a task can be as big as managing a project involving multiple tasks, assigning responsibilities to multiple teams, monitoring activities and progress of each team/team member right from acquiring the project to delivery of the project. Effective task management requires managing all aspects of a task, including task's status, priority, time, human and financial resources and so on.

Currently, several approaches are followed for managing tasks. For instance, small tasks can be managed with a simple to do list on paper or with simple applications/software. For bigger tasks such as project management, there are specialized software, for example workflow or project management software for solving complexity of tasks and time management effectively, which involve methods such as the Kanban method and Gannt chart planning for task planning and management.

However, the methods used in the current approaches are less effective when used for multiple task planning, management and scheduling. Further, the current approaches fail to support dynamic task management for optimizing and balancing the workload. Hence, there exists a need for a solution for effective task planning, scheduling and management.

### SUMMARY

Various embodiments of the present disclosure provide computer implemented systems and methods for managing tasks.

An embodiment provides a computer-implemented method for managing tasks. The method includes receiving a task input, by a processor, where the task input include a task from among a plurality of tasks. The task input is provided by an administrator of the plurality of tasks. The method includes receiving a time frame for the task, by the processor. The time frame includes a start time and an end time. The method further includes receiving a responsibility area associated with the task, by the processor. The responsibility area is selected from one or more responsibility areas of an organization. The method further includes receiving an effort point, where the effort point is associated with an effort needed to complete the task. The processor facilitates display of the task in a digital platform, where the task is displayed with one or more representations of the responsibility area, the time frame and the effort, the one or more representations at least being a color, a shape, and size of the shape.

Another embodiment provides a system for managing tasks. The system includes a memory storing instructions. The system includes a processor configured to execute the stored instructions to cause the system to receive a task input comprising a task among a plurality of tasks from an administrator of the plurality of tasks. The system receives a time frame for the task, where the time frame includes a start time and an end time. The system receives a responsibility area associated with the task. The responsibility area is selected from one or more responsibility areas of an organization. The system further receives an effort point, where the effort point is associated with an effort needed to complete the task. The system facilitates display of the task in a digital platform with one or more representations of the responsibility area, the time frame and the effort. The one or more representations includes at least a color, a shape, and size of the shape.

Another embodiment provides another computer-implemented method for managing tasks. The method includes receiving a task input, by a processor, where the task input include a task from among a plurality of tasks. The task input is provided by an administrator of the plurality of tasks. The method includes receiving a time frame for the task, by the processor. The time frame includes a start time and an end time. The method further includes receiving a responsibility area associated with the task, by the processor. The responsibility area is selected from one or more responsibility areas of an organization. The method further includes receiving an effort point, where the effort point is associated with an effort needed to complete the task. The method further includes facilitating display of the task in a digital platform. The responsibility area is displayed in a bubble of a color corresponding to the responsibility area. The one or more responsibility areas are associated with one or more corresponding colors. A size of the bubble is proportional to the effort point.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an environment in which a computing device, facilitating an application for managing tasks, is deployed, related to at least some embodiments;

FIG. 2 is a flowchart illustrating a method for managing tasks carried out by the application at the computing device, in accordance with an embodiment of present disclosure;

FIG. 3 is an illustration of a user interface of the application at the computing device for creating responsibility areas or organizational levels of an organization, in accordance with an embodiment of present disclosure;

FIG. 4 is an illustration of a user interface of the application at the computing device for creating strategy labels corresponding to the responsibility areas, in accordance with an embodiment of present disclosure;

FIG. 5 is a simplified illustration of responsibility areas and strategy labels, in accordance with an embodiment of present disclosure;

FIG. 6 is an illustration of a user interface of the application at the computing device for creating a task and defining effort point for the task, in accordance with an embodiment of present disclosure;

FIG. 7A is a representation of a user interface of the application at the computing device for facilitating allocation of tasks within time frames, in accordance with an embodiment of present disclosure;

FIG. 7B is a representation of another user interface of the application at another computing device illustrating an alternate way of allocating tasks within time frames and defining effort points, in accordance with an embodiment of present disclosure;

FIG. 8 is a representation of a user interface of the application at the computing device for displaying summary of a task created, in accordance with an embodiment of present disclosure;

FIGS. 9A-9D are illustrations of user interfaces displaying a plurality of tasks as visual objects, in accordance with an embodiment of present disclosure;

FIGS. 10A-10D are illustrations of example user interfaces for creating context stickers and assigning contextual values to a task;

FIG. 11 is an illustration of a user interface displaying velocity and density of tasks within a time frame, in accordance with an embodiment of present disclosure;

FIGS. 12A-12F are illustrations of user interfaces displaying various layouts of the visual objects at different computing devices of an administrator and one or more users (employees or team members) associated with the tasks, in accordance with an embodiment of present disclosure;

FIGS. 13A-13D are illustrations of example user interfaces displaying different arrangements of the tasks based on time frames and priorities at the computing device 102 operated by the administrator and computing devices of one or more users (employees or team members) associated with the tasks; and

FIG. 14 is a block diagram of the computing device, in accordance with an embodiment of present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide computer implemented methods and systems for effectively managing tasks. More specifically, embodiments provide a system that facilitates a digital platform/application/tool for effectively managing tasks. A user such as an administrator may use the digital platform/application/tool to create tasks. The administrator may be a project lead or a project manager of an organization or any person, who is responsible for creating and assigning tasks, corresponding to a project, to users accountable for various tasks related to the project through the life cycle of the project. Examples of the users may include product managers, interns or engineers, etc., of an organization. The administrator uses the digital platform to define responsibility areas or organizational levels, such as, accounting, procurement, design, product management, packaging, compliance, marketing and customer relations, among others. Further, the administrator defines effort or effort points, where effort is the measure of time and resources such as financial and human resources required for completion of a task. The administrator can also define contextual values, where contextual value associated with a task represents the importance of a task. A performance value of a task is calculated based on the effort point and the contextual value associated with the task. Further, a final value of all tasks within a time frame (e.g. a week) is calculated by adding all performance values associated with all tasks within the time frame. The administrator can allocate one or more tasks into a time frame (also known as “sprint” or “bucket”). Allocation of tasks into the time frames may be at least based on existing tasks on backlog. The tasks are displayed in form of visual objects such as bubbles of one or more colors, shapes and sizes. As an example, the color and shape may represent responsibility areas/organizational levels of the organization and the sizes represent effort or effort points.

The administrator can share details or information corresponding to a task with the users (team members/employees) associated with the task at computing devices associated with the users. The system facilitates display of the tasks in form of visual objects such as bubbles at computing devices of the administrator and the computing devices associated with the users (team members) with whom the details of the task have been shared by the administrator. The administrator and the users can, using their respective computing devices, arrange the objects by position and layout to create a specific comprehensible visual pattern thereby prioritizing a plurality of tasks in a visual way. The application displays a status of the tasks. The tasks can be filtered and viewed, wherein the filters are at least based on priority, status, responsibility areas, effort points, time frames, users associated with the tasks and workload.

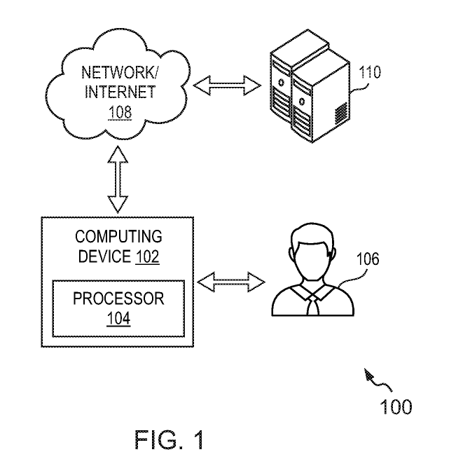

FIG. 1 is a simplified illustration of an example environment 100 related to at least some embodiments disclosed herein. The example environment 100 includes a system such as a computing device 102 comprising a processor 104 and a memory. The memory stores instructions which are executed by the processor 104 to enable an application to run on the computing device 102. The computing device 102 is equipped with instances of the application installed therein. Instances of the application may be made available for download at Google™ play store, Apple™ iOS App store, or other such app stores, among others, where the application can be hosted by a server such as a server 110. The server 110 can be a cloud based server, or physical server located at one or more geographical locations. A user 106 of the computing device 102 can download the application using a communication network 108 that establishes communication between the computing device 102 and a server/virtual store (e.g. server 110, Google play store and app store, etc.,) storing the components of the application.

The application enables several workflows at the computing device 102 as disclosed in some embodiments herein. The application may be a mobile application or a web application. The application provides buttons/actionable icons and fields (for user to enter inputs or to display information to user) at a display interface of the computing device 102, thereby enabling the user 106 to interact with the application using the computing device 102 for effectively managing tasks.

The computing device 102 may be associated with an organization and may be used specifically for the purposes of managing tasks disclosed in the embodiments. Examples of the computing device 102 include, but are not limited to, a personal computer (PC), a processing system such as a server, a tablet device, a personal digital assistant (PDA), a smart phone and a laptop.

The user 106 (hereinafter referred to as “administrator”) is responsible for creating and assigning tasks to a plurality of team members (employees), associated with a project, using the computing device 102. The administrator 106, as an example, may be a project lead or a project manager, who may be responsible for heading the team for execution of the project. Team members may, as an example, include engineers, interns, procurement personnel, accounting personnel and product manager, among others. Each team may represent a specific responsibility area or a department within the organization. It shall be noted that the organization may include various types of companies, institutions, super markets, various service provider entities, etc., where project management and distribution of tasks among teams are essential part of business.

The communication network 108 represents any distributed communication network (wired, wireless or otherwise) for data transmission and receipt between/among two or more points. The communication network 108 may as an example, include standard and/or cellular telephone lines, LAN or WAN links, broadband connections (ISDN, Frame Relay, ATM), wireless links, and so on. Preferably, the communication network 108 can carry TCP/IP protocol communications, and HTTP/HTTPS requests can be communicated over such communication networks 108. In some implementations, the communication network 108 includes various cellular data networks such as 2G, 3G, 4G, and others. Typical examples of the communication network 108 includes a wireless or wired Ethernet-based intranet, a local or wide-area network (LAN or WAN), and/or the global communications network known as the Internet, which may accommodate many different communications media and protocols.

The administrator 106 opens the application in the computing device 102. The application receives a task input from the administrator 106. The task input includes information including name and description of a task to be carried out by one or more teams/team members of an organization. The administrator 106 further provides a time frame for the task. The time frame may also be referred to as a “sprint” or a “bucket”. The time frame has a start time/date and an end time/date for the task. The time frame may correspond to a day, a week, a fortnight or a month, etc.

In an actual use case, the processor 104 may receive a plurality of tasks inputs from the administrator 106, where each task input includes a task (i.e. an identifier or name of the task). The processor 104 further receives a plurality of time frames for the plurality of task inputs, from the administrator 106. Every task of the plurality of task inputs can be allocated with a time frame selected from the plurality of time frames. For instance, the administrator 106 provides the time frame for every task input based on the previous backlog of tasks and/or urgency of tasks.

Prior to providing task inputs, the administrator 106 can use the application to define responsibility areas or organizational levels of an organization. Examples of few responsibility areas include accounting, product management, customer relations, compliance, packaging and logistics, etc. Each responsibility area may be represented by one or more concerned personnel (team member), who may be accountable for different tasks through the life cycle of the project. Each responsibility area may be categorized into strategy labels. Strategy labels are created to break down responsibility areas into smaller sub-levels based on the functions of each team member representing the particular responsibility area. Each strategy label is assigned a unique color and a unique ID (responsibility area and code). Strategy labels may be deleted and recreated.

The processor 104 receives definition of effort points for each task depending upon the effort and time required for completion of the task. Based on the strategy labels and the effort points, the tasks may be displayed by the processor 104 as visual objects. An example of a visual object may be a “bubble”. The tasks are displayed with one or more representations of the responsibility area, the time frame and the effort. In some examples, the one or more representations can be a color, a shape, and size of the shape.

The administrator 106 is provided options in the application to move bubbles (tasks) in and out of a time frame or moving a task from one time frame to another time frame through drag-and-drop technique. Moving bubbles between time frames is a way of balancing workload and maximizing available resources with optimal tasks alignment.

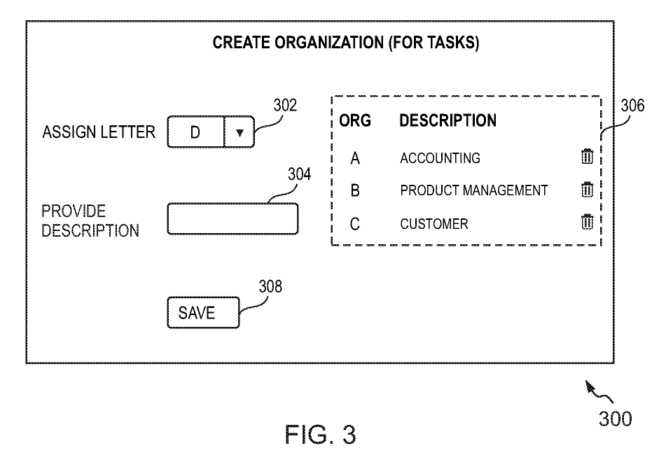

Various example representations of one or more representations will be further explained with reference to FIGS. 3 to 11A-11F.

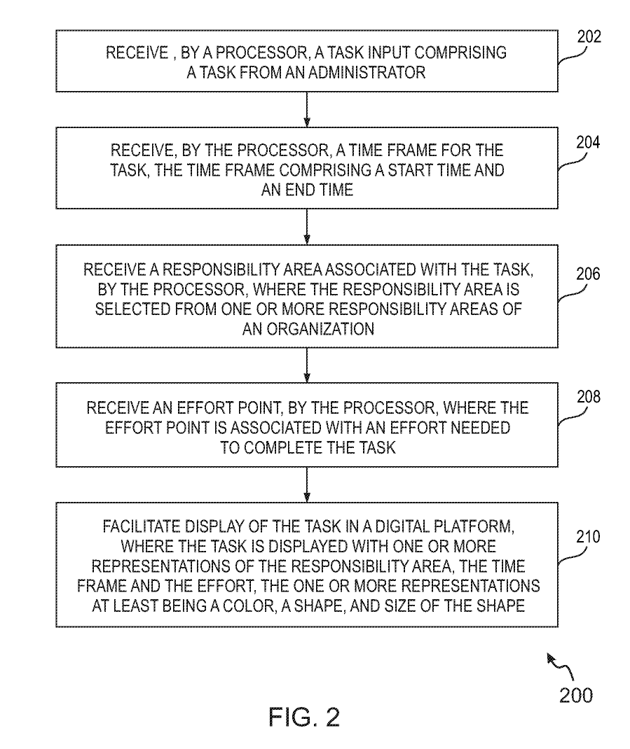

FIG. 2 is a flowchart illustrating a method 200 for effectively managing tasks. One or more operations of the method 200 are carried out at the computing device 102 by the processor 104. The sequence of operations of the method 200 need not be necessarily executed in the same order as they are presented. Further, one or more operations may be grouped together and performed in form of a single step, or one operation may have several sub-steps that may be performed in parallel or in sequential manner. The operations of the method 200 are workflows enabled by the application for effectively managing tasks. The method 200 is a flowchart illustrating creation of one task among a plurality of tasks.

At operation 202, the processor 104 receives a task input comprising a task from among a plurality of tasks. The plurality of tasks may be predefined in the application or can be defined by the administrator 106, as per the need. The task input may include name and description of a task related to the project. The task input is received from the administrator 106 in the application at the computing device 102. The plurality of tasks may, as an example, relate to responsibilities of various users (team members) representing different responsibility areas within an organization through the life cycle of a project. As an example, in a general scenario, the plurality of tasks may be raising an invoice, creating an accounts page, packaging components, shipping a number of items to a location, and so on. Each of these tasks may relate to responsibility areas such as procurement of items/materials, accounting/auditing, design, development, package and shipping, among others.

At operation 204, the processor 104 receives a time frame for the task. The time frame (sprint or bucket) may be a time window having a start time/date and an end time/date corresponding to the task. In an embodiment, each task is allocated with a time frame based at least on previous backlog of tasks or the urgency of the task at hand. One or more tasks received in one or more task inputs can be allocated by the administrator 106 into a single time frame. The application may provide controls such that the administrator 106 and the users associated with the tasks can, using the controls, drag and move tasks between the time frames to optimize resources and balance workloads. Tasks can be dragged and moved between time frames to create a visual layout and a pattern comprehensible to the administrator 106 and the users (team members) associated with the tasks.

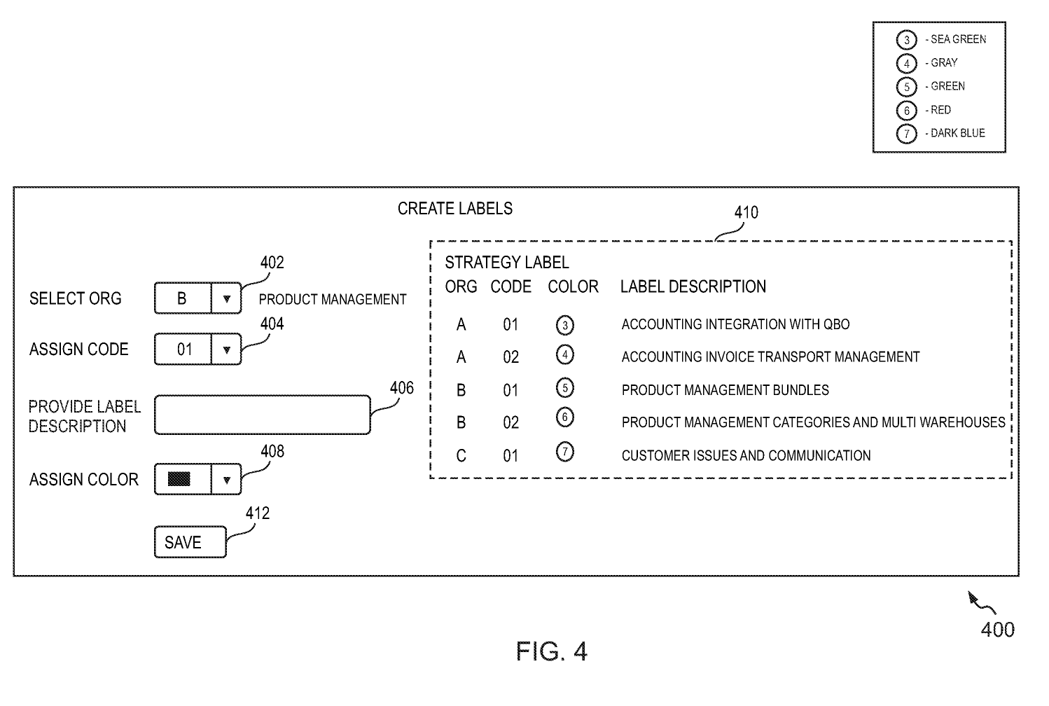

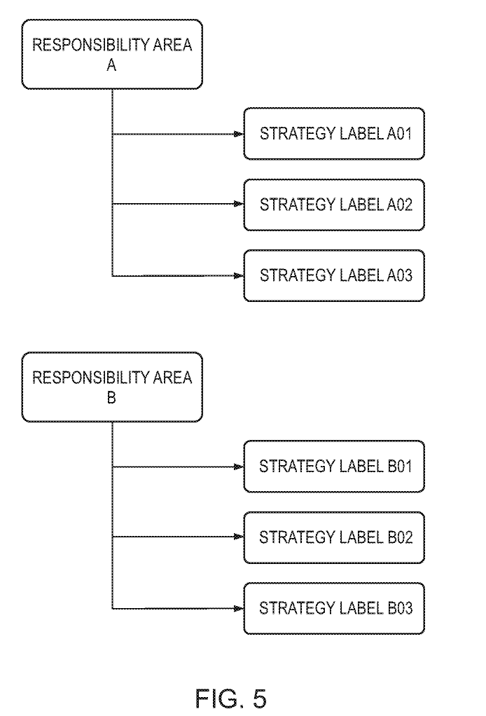

At operation 206, the processor 104 receives definition of a responsibility area associated with the task. The responsibility area may be predefined or created by the administrator 106 using the application. The responsibility area may be selected from one or more predefined or created responsibility areas of an organization. As described earlier, examples of few responsibility areas include procurement of items/materials, accounting, design, development, package and shipping, among others. Each responsibility area defines a task/task category. In an example, each responsibility area is assigned a letter (e.g. “A, B, C . . . Z”, shown in FIG. 3). Further, each responsibility area is categorized into strategy labels (shown in FIGS. 4 and 5). Strategy labels are created to break down responsibility areas into smaller sub-levels based on the functions of the team members. Each strategy label is an organizational grouping of important strategical features.

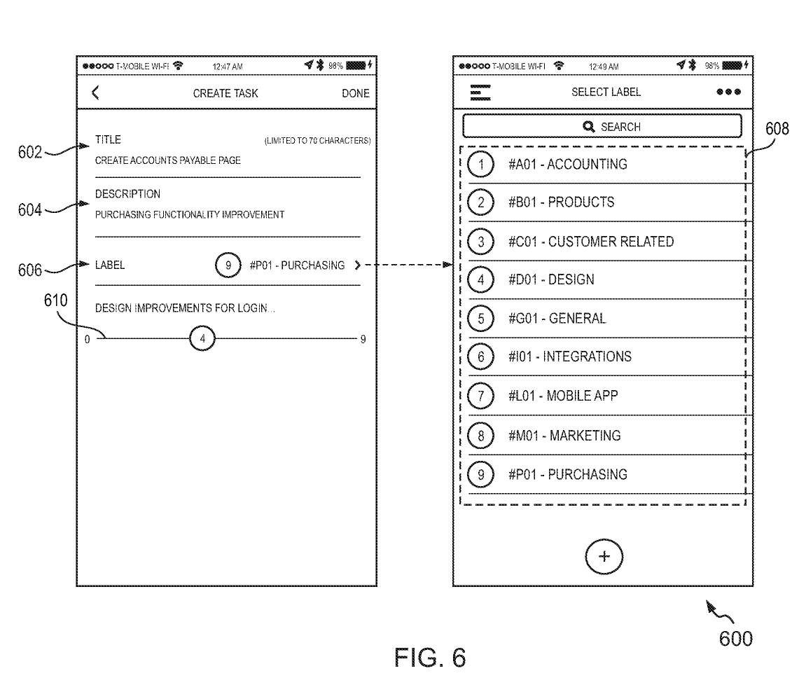

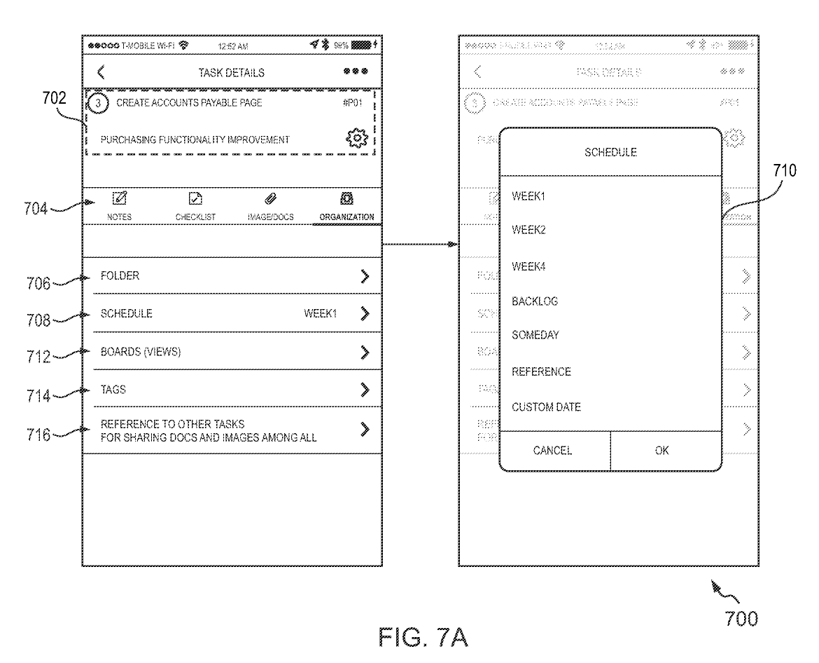

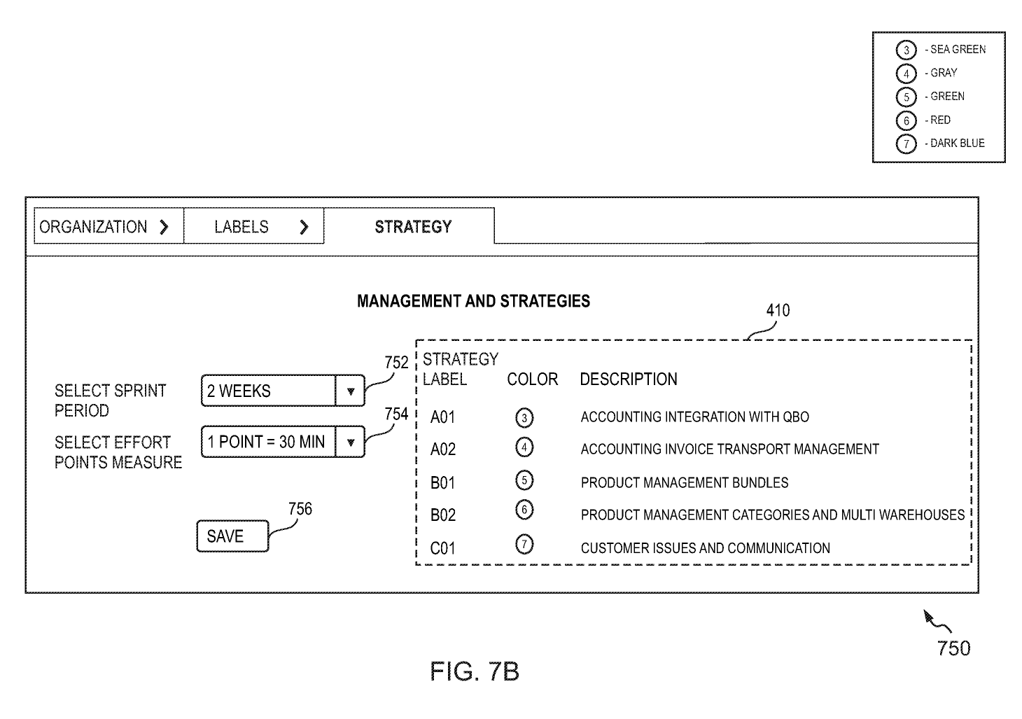

At operation 208, the processor 104 receives an effort point associated with the task. The administrator 106 defines effort points for each task depending upon the effort and time required for completion of the task. The application may provide options (shown in FIG. 6, FIGS. 7A and 7B) to set/define effort points or measure of effort points say 0, 2 or 9 required for completion of a task. The administrator 106 can access the application in the computing device 102 to define effort points.

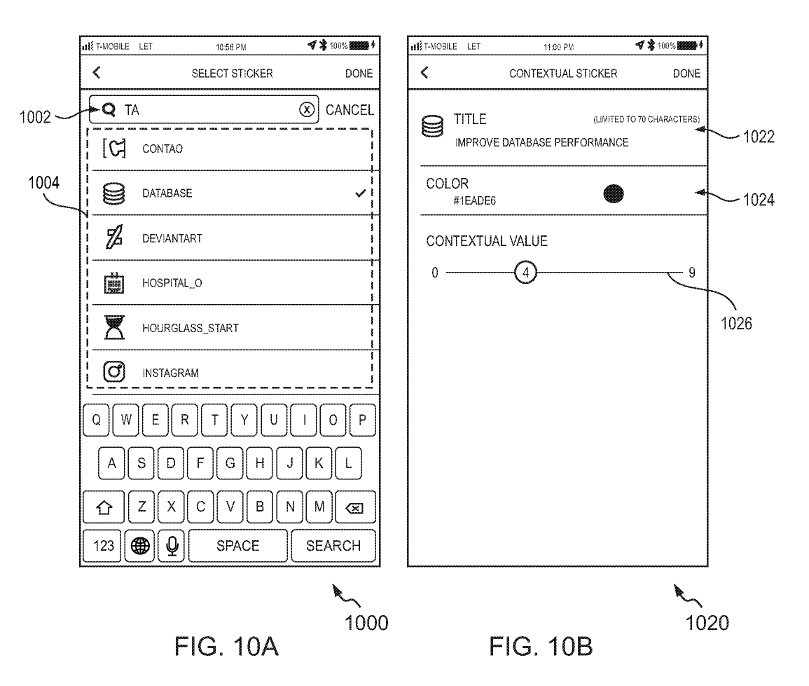

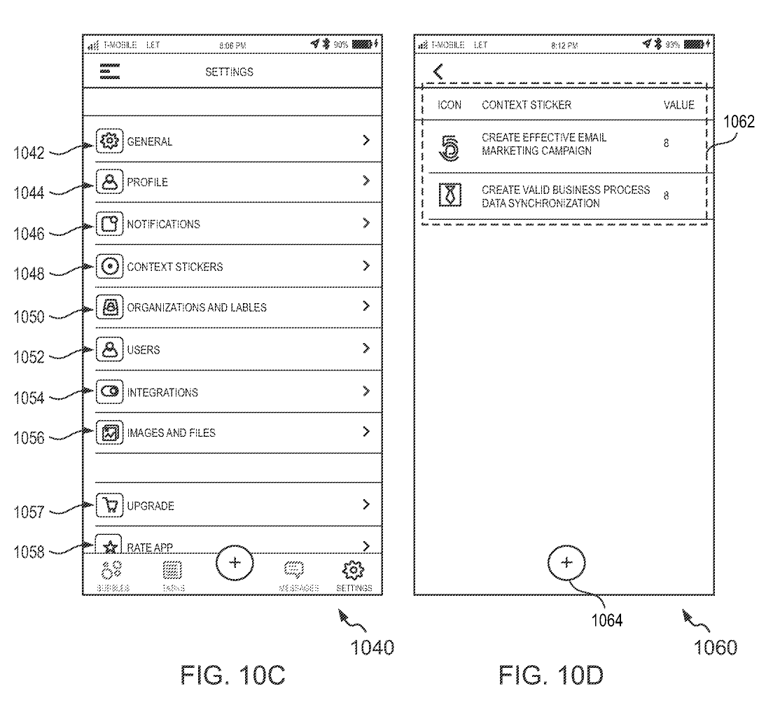

In some embodiments, the administrator 106 defines contextual values for each task depending upon the importance of the task. The contextual value may be a number that represents the importance of the task. The administrator 106 may access application at the computing device 102 to set/define contextual values say 0, 2 or 9 (e.g., see FIG. 10B). In an example embodiment, the contextual value for each task may be provided within the shape representing the task. In another example embodiment, the contextual value for each task may be provided outside the shape representing the task.

At operation 210, the processor 104 facilitates display of the task in the application. In an embodiment, the task is displayed with one or more representations of the responsibility area, the time frame and the effort. Examples of the one or more representations can at least be a color, a shape, and a size of the shape. In a non-limiting example, the shape may be a bubble or a circle, and all representations can be made by including different colors/patterns in the shape (i.e. bubble) and/or including text within the bubble, etc. For instance, color included within the shape (i.e. the bubble) represents the strategy label(s) associated with the task and the size represent the effort points needed for completion of the task. The one or more representations of the task are also displayed at devices (not shown) of one or more users, such as team member, employees, review committee of an organization, associated with the tasks. In an example embodiment, the tasks may be represented as visual objects of various shapes such as rectangle, square, hexagon, triangle, parallelogram, etc., to define the responsibility area while size defines the effort points.

In an embodiment, each strategy label is assigned a unique color (e.g. green for “design” and yellow for “procurement”) and a unique ID representing the responsibility area (e.g. A). Each strategy label is further assigned a code (e.g. 01) to represent a function within a responsibility area. Strategy labels may be deleted and recreated. Some examples of such representations will be described with reference to FIGS. 3 to 11A-11F.

Referring to FIG. 3, the application in the computing device 102 facilitating a user interface 300 for defining responsibility areas/organizational level is illustrated. The user interface 300 includes a field 302 which allows assigning a letter (e.g. A, B, C, D . . . Z) to represent a particular responsibility area/organizational level. As an example, a letter “A” may represent “accounting”, letter “B” may represent “product management”, and so on. Field 302 may be a drop down menu as seen in the FIG. 3. Alternatively or additionally, the field 302 may allow the administrator 106 to provide text input to indicate the responsibility area. The user interface 300 further provides a field 304 where the administrator 106 can input a description corresponding to the responsibility area. Description may include the name (e.g. Product management) of the particular responsibility area. The user interface 300 includes a field 306, which provides a list of letters representing the responsibility areas along with their corresponding description. The field 306 may display options to delete or edit the responsibility area from appearing in the list. The user interface 300 includes an actionable icon 308 indicating “save”, selection of which may allow saving the responsibility areas and the description within the application in the computing device 102.

Referring to FIG. 4, a user interface 400 of the application for defining strategy label and assigning colors to each strategy label, is illustrated, in an example embodiment. In this example representation, the user interface 400 includes a field 402 which allows selecting a letter (e.g. A, B, C, D . . . Z) that represents a particular responsibility area/organizational level. As an example, if the letter “B” is selected in the field 402, then the strategy label that will be created is related to the responsibility area “product management”. The field 402 may be a drop down menu as seen in the FIG. 4. Alternatively or additionally, the field 402 may enable a user to type the letter that represents the responsibility area. The user interface 400 further provides a field 404, which allows selecting a code (e.g. 00, 01, 02 . . .) that represents the strategy label corresponding to the responsibility area represented by the letter selected in the field 402. As an example, if the letter “B” is selected in the field 402 and a corresponding code “01” is selected in the field 404, then the strategy label denotes “product management bundles” which may be a sub category within the responsibility area “product management”. The field 404 may be a drop down menu as seen in the FIG. 4. The user interface 400 further provides a field 406 where the administrator 106 can input a description corresponding to the strategy label. Description may include the name of the particular strategy label. The user interface 400 includes a field 408 that allows assigning colors (e.g. green, yellow, red, purple, etc) to the selected strategy label. As an example, a green color bubble, after selection, is assigned to the strategy label “product management bundles” which is a sub category within the responsibility area “product management”.

In FIG. 4 and other figures, numbers such as 1, 2, 3, 4, 5, 6, 7, 8, 9, 10 and 11, included within a circle represent different colors. As an example, in FIG. 4 and other figures, 1 represents sky blue, 2 represents dark red, 3 represents sea green, 4 represents gray, 5 represents green, 6 represents red, 7 represents dark blue, 8 represents black, 9 represents light green, 10 represents mint green,11 represents blue, and so on.

The user interface 400 further displays a field 410, which provides a list of letters (e.g. A, B, C . . . . ) representing the responsibility areas along with the code (e.g. 01, 02, 01 . . . . ) representing the strategy label, and the color (e.g. red, magenta, green) assigned to or to be assigned to the strategy labels. The field 410 also includes corresponding description (e.g. “accounting integration with QBO”, “account invoice transport management”, “product management bundles”, “product management categories and multi warehouses”, etc) of the strategy labels. The user interface 400 includes an actionable icon 412 indicating “save”, selection of which may allow saving the responsibility areas, the corresponding strategy labels, the code and the color assigned to each strategy label and the description in the application in the computing device 102.

Referring to FIG. 5 an example representation of responsibility areas/organizational levels and their corresponding sub categories, i.e. the strategy labels are illustrated. As seen in the FIG. 5, an example responsibility area “A” may be categorized into three strategy labels, e.g., strategy label A01, A02 and A03, depending upon the responsibilities and functions Likewise another example responsibility area “B” may be categorized into three strategy labels, e.g. strategy label B01, B02 and B03, depending upon the responsibilities and functions of the team members.

It shall be noted that, prior to defining responsibility areas, strategy labels, assigning colors and codes to the strategy labels, defining effort points, the application may provide a user interface (see 600 in FIG. 6) allowing the administrator 106 to create a task, add a name or a title to the task, add a description for the task, assign the task to an individual employee, to more than one employee or to a team. The user interface 600 can be accessed in the application subsequent to defining responsibility areas, strategy labels assigning colors and codes to the strategy labels and before defining effort points for the tasks.

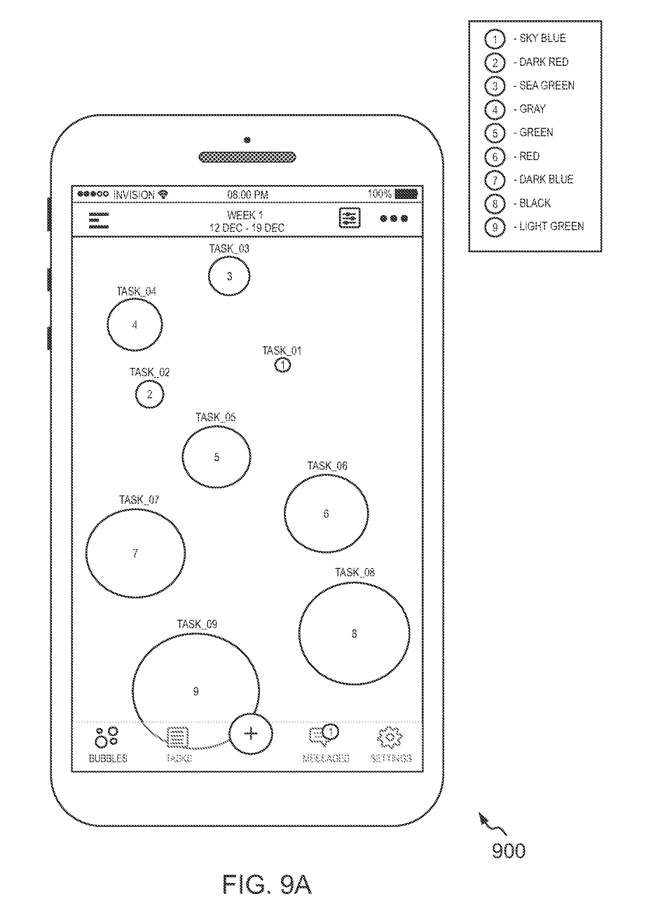

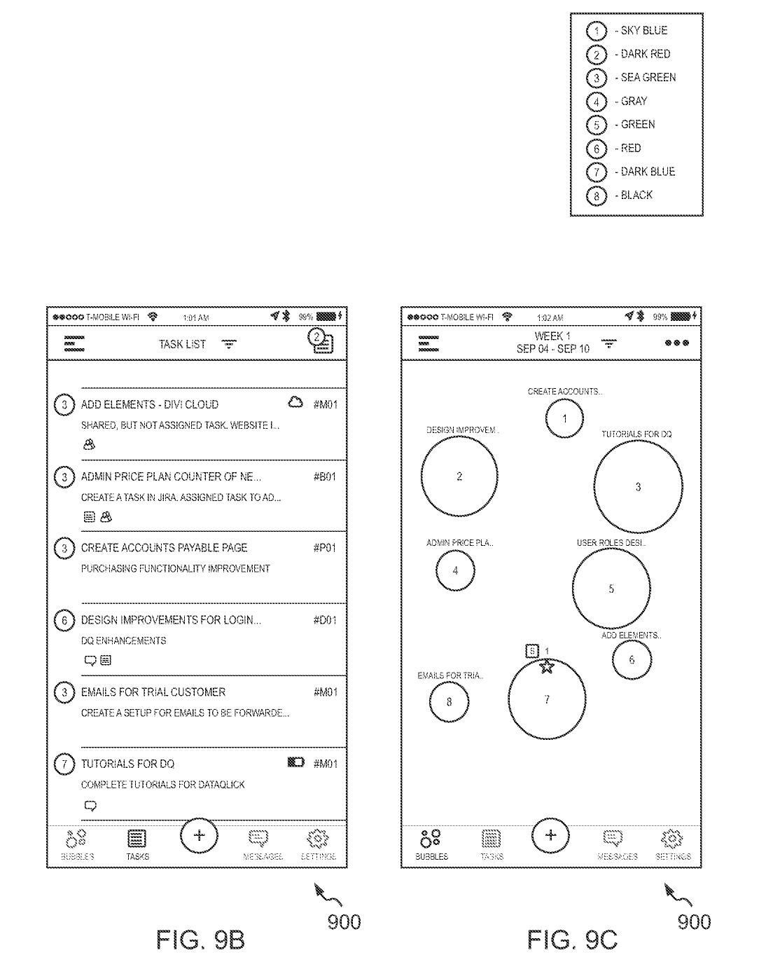

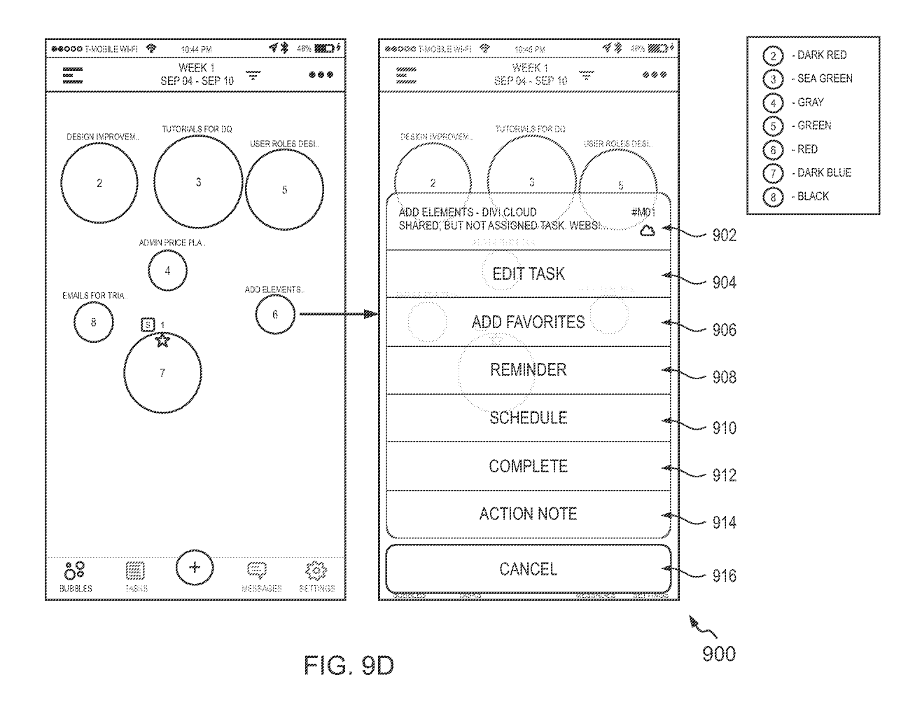

FIG. 6 is an example user interface 600 of the application allowing the administrator 106 to create a task, in accordance with an example embodiment. The user interface 600 enables a field 602 that allows the administrator to provide a name/title (e.g., “Create accounts payable page”) of the task and a field 604 that allows providing a description (e.g., “purchasing functionality improvement”) of the task. The user interface 600 provides a field 606 which displays the strategy label corresponding to the task. The field 606 displays the strategy label including the color (e.g. a green colored bubble shown as 9), the code and description (e.g. “#P01 Purchasing”) of the strategy label by the administrator 106. Selection (long pressing) of the field 606 may display a page (a pop up) comprising a list 608 of all defined strategy labels (define in user interface 400, see FIG. 4) thereby enabling the administrator 106 to select from the list 608. Further, the user interface 600 may display a slider/scale 610 comprising a minimum value and a maximum value (not shown) for defining effort points for a task. The administrator 106 may drag or move the slider 610 between the maximum value (say 9) and the minimum value (say 1). A task with an effort point of 9 may require more effort, more time and resources (e.g. financial and human resources). Such a task is displayed as a bubble of relatively bigger diameter (shown in FIG. 9A). Likewise, a task with an effort point of 2 may require less effort, lesser time and resources. Such a task is displayed as a bubble of relatively smaller diameter (shown in FIG. 9A).

Referring to FIG. 7A, the application in the computing device 102 facilitates a user interface 700 for providing a time frame for a task and allocating the task with the time frame. The user interface 700 includes a field 702 which displays the name and description of a task created (at the user interface 600) along with the color and code assigned for the strategy label corresponding to the task. A field 704 includes actionable icons including notes, checklist, images or other documents and organization. Selection of each of these actionable icons may redirect the administrator 106 to another page instructing the administrator 106 to perform actions on the page. Further, selection of each of these actionable icons may open pop ups displaying lists of one or more notes, checklists, images and documents and organizations. The user interface 700 includes a field 706 indicating folders, selection (long pressing) of which may open a pop up displaying list and names of folders or files related to the task.

The user interface 700 includes a field 708 indicating schedule and a description of the schedule (e.g. 1 week), wherein the schedule describes the time period required to complete the task. Selection of the field 708 opens a pop up which includes a list 710 of time periods to be used as schedules (e.g., week 1, weeks 2, backlog, custom date etc.). Selection of option “custom date” from the list may allow the administrator 106 to provide a date (tentative) on which the task is due. The pop up further displays actionable icons “ok” and “cancel”. Selection of “ok” enables saving the time period as the schedule for the task and selection of “cancel” enables cancelling the time period as the schedule for the task.

The user interface 700 includes a field 712 indicating “boards”, selection (e.g., long pressing) of which may open a pop up displaying boards related to the task. The user interface 700 includes a field 714 indicating “tags”, selection (long pressing) of which may open a pop up displaying tags related to the task. The user interface 700 further includes a field 716 indicating “reference to other tasks”, selection (long pressing) of which may open a pop up displaying other tasks related to the task created at the user interface 600.

Referring to FIG. 7B, the application in the computing device 102 facilitates a user interface 700 displaying an alternate way of allocating time frame for a task and defining effort points for the task. The user interface 750 includes a field 752 which allows selecting a time period (e.g. a day, 5 hours, 60 hours, 2 weeks, etc.) for a specific task. Field 752 may be a drop down menu as seen in the FIG. 7B. Alternatively or additionally, field 752 may enable a user to type the time period for the task in form of text input. The user interface 750 further provides a field 754, which allows defining an effort point/effort measure in terms of time period required to complete the task (e.g. 1 point=30 mins, 9 points=75 hours, etc). The user interface 750 may display the field 410 (as shown in FIG. 4), which provides a list representing the responsibility areas along with the codes representing the strategy label, the color assigned to or to be assigned to the strategy labels and the corresponding description of the strategy labels. The user interface 750 includes an actionable icon 756 indicating “save” selection of which may allow saving the time period assigned for a task and the effort points/effort measure in the memory of the computing device 102.

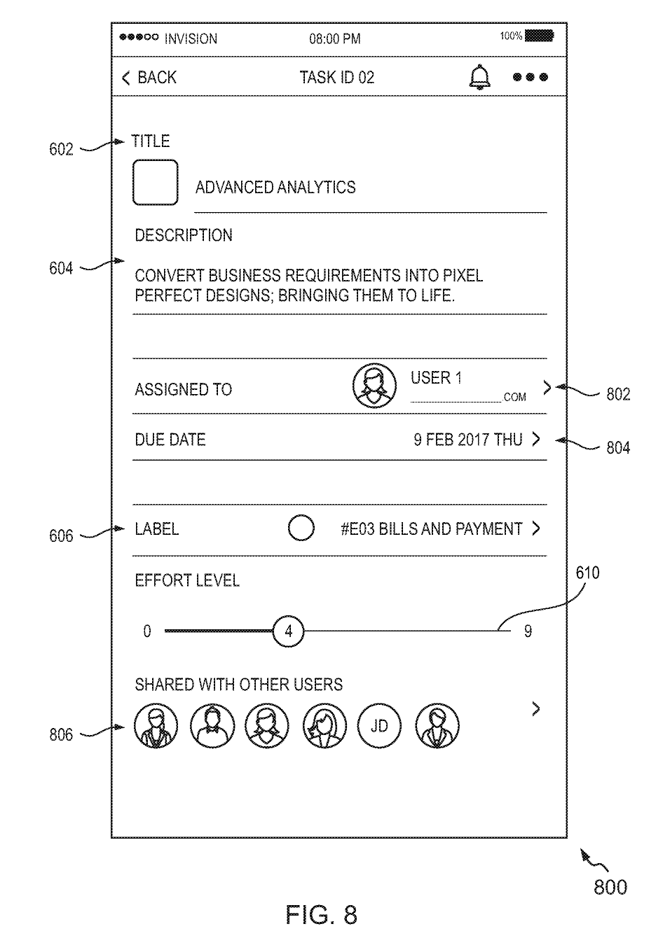

FIG. 8 is an example user interface 800 of the application which may be an extension of the user interface 600. The user interface 800 displays a summary of an example task with a task identifier “Task ID 02”. The user interface 800 includes the field 602 which displays the name/title (e.g. “Advanced analytics”) of the task and the field 604 which displays the description of the task. The user interface 800 provides a field 802 which displays the name of the user/employee(s)/team (e.g. “User 1” as shown in FIG. 8) to whom the task is assigned. A field 804 displays a date and a day (e.g. 9 Feb. 2017, Thu) on which the task is due. The user interface further displays the field 606 which displays the strategy label including the color (e.g. a yellow colored bubble), the code and description (e.g. “#E03 Bills and Payment”) of the strategy label defined by the administrator 106. Further, the user interface 800 includes the slider/scale 610 as described earlier. A field 806 displays one or more other users (team members/employee(s)) with whom the administrator 106 can share the task or who may be associated with one or more related tasks. The field 806 includes bubbles or actionable icons representing the one or more other users, and selection of these actionable icons in the field 806 may direct the administrator 106 to a page which enables the administrator 106 to share the task with the contact information of the one or more other users represented by the actionable icons.

Referring to FIGS. 9A-9D, a user interface 900 displays the tasks in form of visual objects such as bubbles. The tasks as seen in the FIGS. 9A-9D are tasks scheduled for a week. The bubbles are of different sizes based on the effort points assigned to the task. One or more bubbles further represent one or more strategy labels. Strategy labels can be represented in different colors. For the sake of schematic illustration of colors, in FIGS. 9A-9D, bubbles are illustrated with different numbers (e.g. 1, 2, 3, 4 . . . . ) where each number may correspond to a color that defines a strategy label. For example, 1 corresponds to the color sky blue, 2 corresponds to the color dark red and so on. In some scenarios, the bubbles may be displayed with corresponding task names, descriptions, unique codes used for the strategy labels and even task identifiers. FIG. 9B illustrates a list view of the bubbles displaying the tasks in form of bubbles comprising different numbers. The list of tasks includes the unique codes used for the strategy labels. Further, the task list displays the name and the task description of each task. Alternatively and additionally, the task list may include contextual values (not shown) in place of the unique codes used for the strategy labels. FIG. 9C illustrates representation of tasks in different colors (represented by numbers) for a particular week of September 4 to September 10. Further, the name and the task description of each task are provided at positions, such as, top, right, left and bottom of each bubble. Alternatively and additionally, the bubbles may be provided with contextual values (not shown). The arrangement of the tasks as shown in FIG. 9C is an example of a freestyle arrangement, where tasks are not arranged based on priorities.

Referring to FIG. 9D, the administrator 106 may select (long press, tap or touch) one of the bubbles, which opens a page (pop up) displaying a list 902 including one or more actionable icons that indicate actions to be performed on the bubbles with regards to the task. The list 902 includes actionable icons such as edit task 904, add to favorites 906, reminder 908, schedule 910, complete 912 and action note 914. Selection of these actionable icons 904 to 914 may enable one or more changes to be applied to the bubbles. The changes may include editing a task, adding the task to a list of favorite tasks, scheduling the task for later, etc. An actionable icon 916 representing “cancel” may be selected in order to close the list 902 of the actionable icons.

FIGS. 10A-10D illustrate example user interfaces 1000, 1020, 1040 and 1060 for creating context stickers and assigning contextual values to a task. The user interface 1000 may be enabled in the application at the computing device 102 after the task is created as illustrated in FIG. 6 and after setting the effort point for the task as illustrated in FIG. 8. Referring to the user interface 1000, a field 1002 may be provided. The field 1002 may be a search field that allows the administrator 106 to provide text inputs, wherein the text input may be indicative of a context sticker. A field 1004 displays a list of context stickers from which the administrator 106 can select and assign a context sticker to a task. As shown in FIG. 10A, the field 1004 displays context stickers associated with database, instagram, among others. The context stickers may be used to indicate the type and context of the task.

Referring to the user interface 1020 in FIG. 10B, a field 1022 may be provided. The field 1022 allows the administrator 106 to provide a name/title (e.g., “Improve database performance”) of the task. The field 1022 may also display the context sticker assigned to the task at the user interface 1020 next to the title. A field 1024 displays the strategy label corresponding to the task. The field 1024 displays the strategy label including the color (e.g. a green colored bubble shown as 9), the code and description (e.g. “#1EADE6”) of the strategy label by the administrator 106. Further, the user interface 1020 may display a slider/scale 1026 comprising a minimum value and a maximum value (not shown) for defining contextual value for a task. The administrator 106 may drag or move the slider 1026 between the maximum value (say 9) and the minimum value (say 1). A task with a contextual value of 9 may be important and demands urgency or require more time and resources (e.g. financial and human resources). Likewise, a task with a contextual value 2 may be scheduled for later as it may not be relatively important and require lesser time and resources.

The user interface 1040 of FIG. 10C displays a settings menu including a plurality of actionable icons 1042, 1044, 1046, 1048, 1050, 1052, 1054, 1056, 1057 and 1058. The user interface 1040 may be displayed at the computing device 102. The actionable icon 1042 allows the administrator 106 to perform general setting related to the application. General settings may be related to display of the bubbles (tasks), users who may view the tasks and arrangement of the bubbles, etc. The actionable icon 1044 is a “profile” icon which allows the administrator 106 to edit his/her profile. The actionable icon 1046 is a “notification” icon which allows the administrator 106 to control the notifications.

The actionable icon 1048 is a “context sticker” icon which allows the administrator 106 to select and assign context stickers to the tasks. The context sticker may be displayed along with the contextual value in the display of the shapes (bubbles) representing the tasks. Long pressing the actionable icon 1048 displays a pop up page 1060 which includes a list 1062 of previously defined context stickers. The application allows the administrator to add context stickers by selecting the actionable icon 1064 (“+”). Selection of the actionable icon 1064, opens the user interface 1000 shown in FIG. 10A.

The actionable icon 1050 is an “Organization and labels” icon which allows the administrator 106 to edit settings of organizational levels and strategy labels which are created earlier. Creating organizational levels and strategy labels are described earlier with reference to FIGS. 3-4. The actionable icon 1052 is “users” icon which allows the administrator 106 to edit settings related to users. As an example, the actionable icon 1012 may allow the administrator 106 to add or remove the users who can view the tasks. The actionable icon 1054 is an “integration” icon and the actionable icon 1056 is an “images and files” icon which allows the administrator 106 to control settings of documents such as images and files related to tasks. The actionable icon 1057 is an “upgrade” icon which allows the administrator to upgrade the application and the actionable icon 1058 is a “rate app” icon which allows the administrator 106 to rate the application.

In some embodiments, the administrator 106 can provide a resource limit input for the tasks. The resource limit input defines the resources required for completion of the tasks allocated into a time frame. The processor 104 of the computing device 102 further facilitates display of a velocity point based on the resource limit input. Velocity point defines the resource limit for a time frame, where resource may be in terms of time, finance and labour. Velocity point is an attribute that is used by the team as available combined resources or just a single (personal) level of resource limit. The level of the velocity point is determined by the administrator 106. This level is typically established based on experience and the administrator 106 can adjust it based on history of previous time frames, achievements and desired level of comfort, balance and workload. The processor 104 further facilitates display of a density point associated with a time frame or the tasks within the time frame. Density defines the summary of all effort points or a collective measure of all effort points within a time frame.

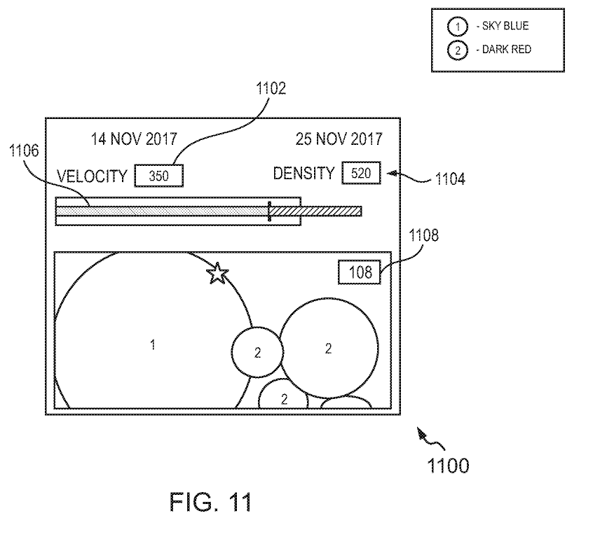

In an embodiment, a performance value associated with a task may be calculated by the application. The performance value of a task is calculated by multiplying the effort point and the contextual value of the task. A final value or final performance value (see 1108 in FIG. 11 and other Figures) is calculated for a given time frame using the performance values of the one or more tasks allocated within the given time frame. For a given time frame (say a week), the final value is the addition of the performance values of the one or more tasks. The final value represents the overall performance of all tasks for the given time frame. The application facilitates establishing weekly final values. From the weekly final values, the users can measure his/her productivity more effectively. As an example, for the week 14 Nov. 2017-25 Nov. 2017, two tasks (Task 01, Task 02) are scheduled and completed. Let's consider effort point for Task 01 is 4 and the contextual value is 3. The performance value of the Task 01 is calculated to be (3*4) 12. Likewise, effort point for Task 02 is 2 and the contextual value is 8. The performance value of the Task 02 is calculated to be (2*8) 16. Hence, the final value or the final performance value for the week 14 Nov. 2017-25 Nov. 2017 is (12+16)=28. A higher final value of the tasks that are completed, suggests an effective/optimized allocation and management of tasks.

Referring now to FIG. 11, a user interface 1100 provides a display of tasks scheduled for a week displaying a velocity point and a density point for the time frame. As an example, one or more tasks are allocated within a time frame of 1 week (14 Nov. 2017-25 Nov. 2017). The user interface 1000 displays a velocity field 1002 displaying a velocity point “350” which is a measure of the resource limit required for completion of all the tasks scheduled between 14 Nov. 2017 and 25 Nov. 2017. The user interface 1100 further displays a density field 1104 displaying a density point “520” which indicates a summary or cumulative measure of effort points of all the tasks within the time frame. The application displays a graphical representation 1106 of the velocity point vs. the density point distribution. The application may allow the administrator 106 to provide the velocity point in the velocity field 1102 and provide the density point in the density field 1104 in form of text input. A final value 1108 (e.g., 108) of all the tasks for the week 14 Nov. 2017 to 25 Nov. 2017 may be displayed at the user interface 1100. Further, the task names, the effort point and the contextual value of each task for the week 14 Nov. 2017 to 25 Nov. 2017 may be displayed next to the bubbles at the user interface 1100.

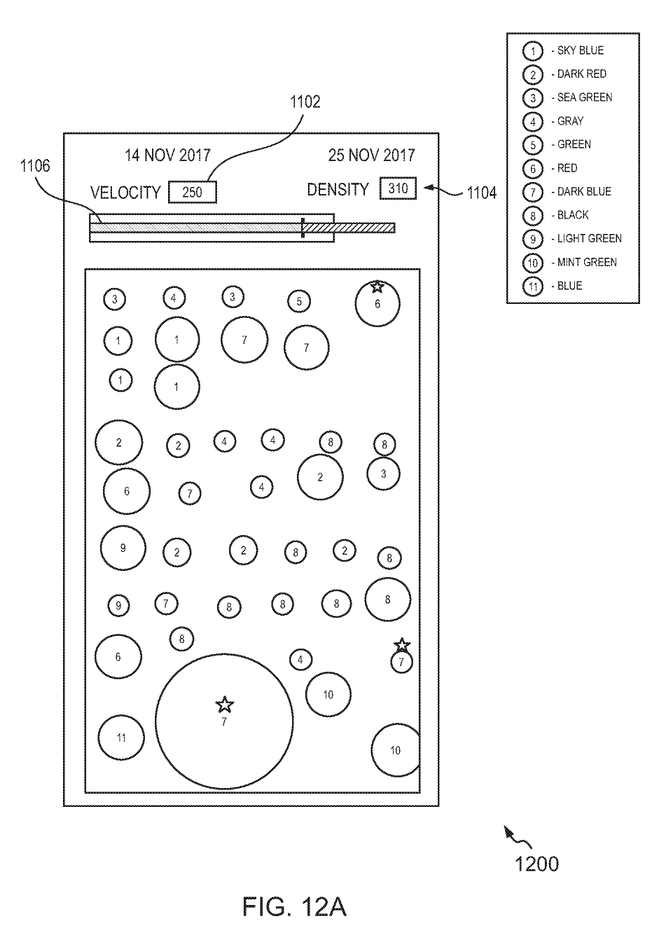

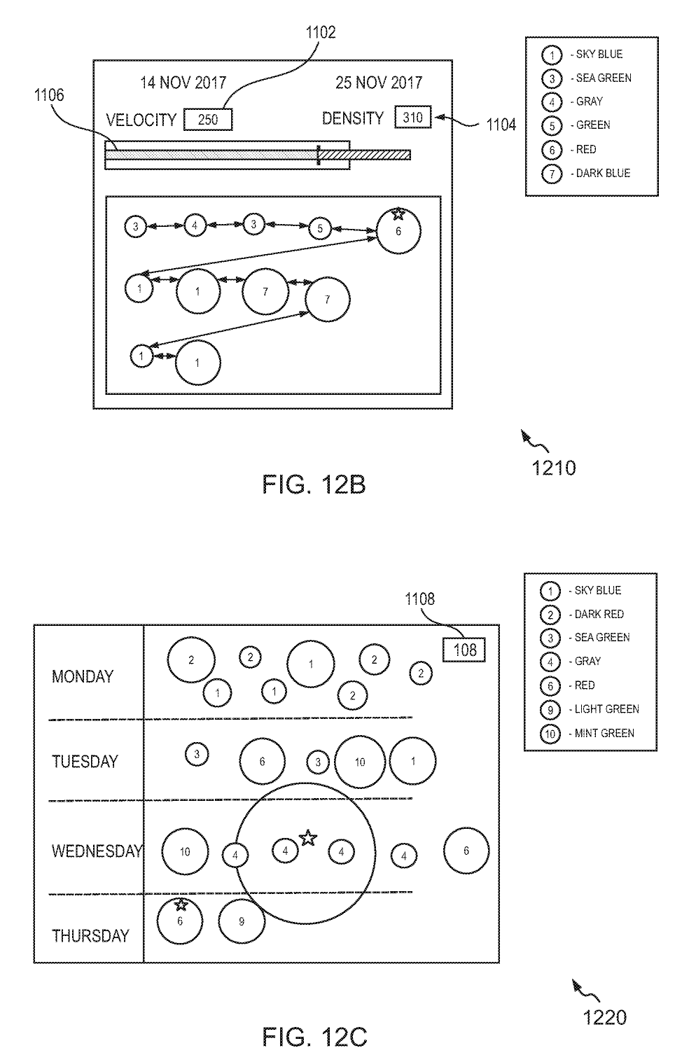

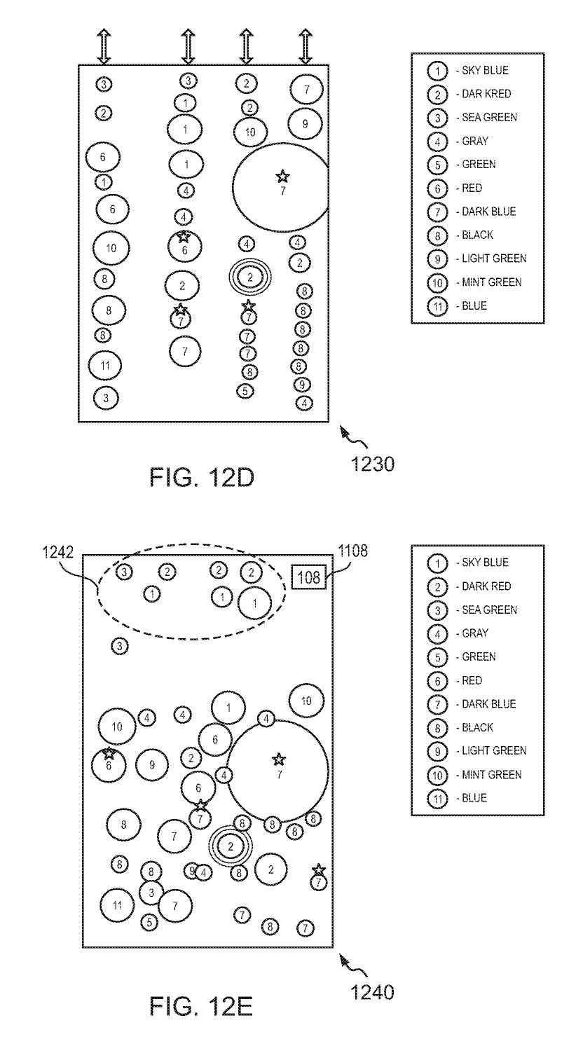

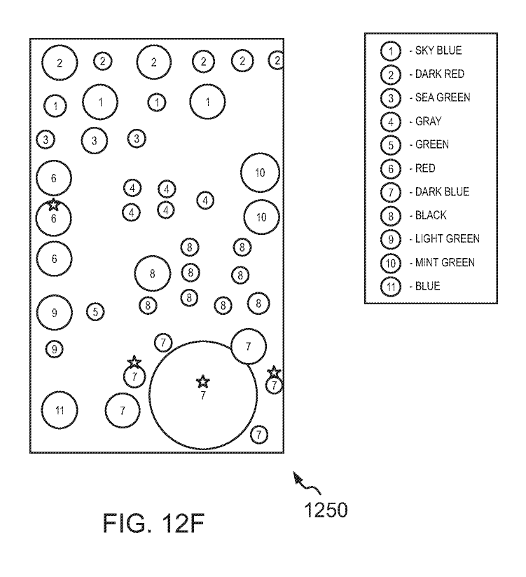

FIGS. 12A-12F illustrate user interfaces 1200, 1210, 1220, 1230, 1240 and 1250 displaying various layouts and arrangements of the tasks at the computing device 102 operated by the administrator 106 and computing devices (not shown) of the users (employees or team members) associated with the tasks and with whom the tasks have been shared by the administrator 106. The users may be one or all of the users included in the field 806 of the user interface 800 to whom the administrator 106 may have shared the tasks. In other words, only those users who are associated with a task or who may be assigned a task by the administrator 106 may receive the details of the task and can view the tasks at their respective computing devices. The application may further facilitate defining controls by the administrator 106 for the users in order to arrange the layouts and positions of the tasks in their respective computing devices. Control can be in form of providing input, adding a sub-task to a task, updating status of a task, etc.

It shall be noted that one or more user interfaces among user interfaces 1200, 1210, 1220, 1230, 1240 and 1250 may be examples of the user interface 1000 displaying different layouts of the bubbles (tasks). The bubbles in 12A-12F are displayed with numbers (e.g. 1,2,3,4) where each number corresponds to a color and where each color and a unique code represents a strategy label (e.g. a red coloured bubble with unique code A01 represents the strategy label “accounting integration with QBO”) As an example, 1 represents sky blue, 2 represents dark red, 3 represents sea green, 4 represents gray, 5 represents green, 6 represents red, 7 represents dark blue, 8 represents black, 9 represents light green, 10 represents mint green and 11 represents blue. The final value 1108 of all the tasks for the week 14 Nov. 2017 to 25 Nov. 2017 may be displayed (not shown) at the user interfaces 1200, 1210, 1220, 1230, 1240 and 1250. Further, the task names, the effort point and the contextual value of each task for the week 14 Nov. 2017 to 25 Nov. 2017 may be displayed next to the bubbles (not shown) at the user interfaces 1200, 1210, 1220, 1230, 1240 and 1250.

FIG. 12A is a user interface 1200 displaying a layout of the tasks arranged from top to bottom based on sequential order for a week from 14 Nov 2017 to 25 Nov 2017. The user interface 1200 displays the velocity field 1102, the velocity point (see, 250), the density field 1104, a density point (see, 310) and the graphical representation 1106 of the velocity point vs. density point distribution.

FIG. 12B illustrates a user interface 1210 displaying the strategy of working of the tasks for a week from 14 Nov 2017 to 25 Nov 2017. The user interface 1200 displays the velocity field 1102, the velocity point, the density field 1104, the density point and the graphical representation 1106 of the velocity point vs. density point distribution. The bubbles are arranged in rows. The user interface 1210 includes arrows (as shown) wherein the direction (→) of the arrows defines the priority/order in which the tasks are to be performed. As an example, in the first row of bubbles shown in FIG. 12B, task represented by the bubble with number “3” may be followed by a task represented by the bubble with number “4” and so on.

FIG. 12C illustrates a user interface 1220 displaying tasks organized by days of the week. For example, tasks represented by the bubbles with numbers “1”, and “2” are scheduled for Monday, and so on. The administrator 106 can organize the tasks by drag-and-drop functionality. Based on the organization of the tasks, the administrator 106 can decide the workload for any given day. The final value 1108 of all the tasks for a week (e.g. 14 Nov. 2017 to 25 Nov. 2017) may be displayed.

FIG. 12D illustrates a user interface 1230 displaying tasks organized in form of columns. FIG. 12E illustrates a user interface 1240 displaying dynamic selection of tasks for daily processing. A user (team member) picks up tasks that he/she wants to complete in a particular day (e.g., see, tasks included in an area 1242). FIG. 12F illustrates a user interface 1250 displaying a layout where tasks are grouped based on the strategy labels. For example, tasks represented by the dark red colored bubbles (see, with numbers “2”) may correspond to a strategy label (e.g. “accounting integration with QB0”, shown in FIG. 4) and may be grouped together. The arrangement of the tasks as shown in FIGS. 12A-12F are examples of freestyle arrangement.

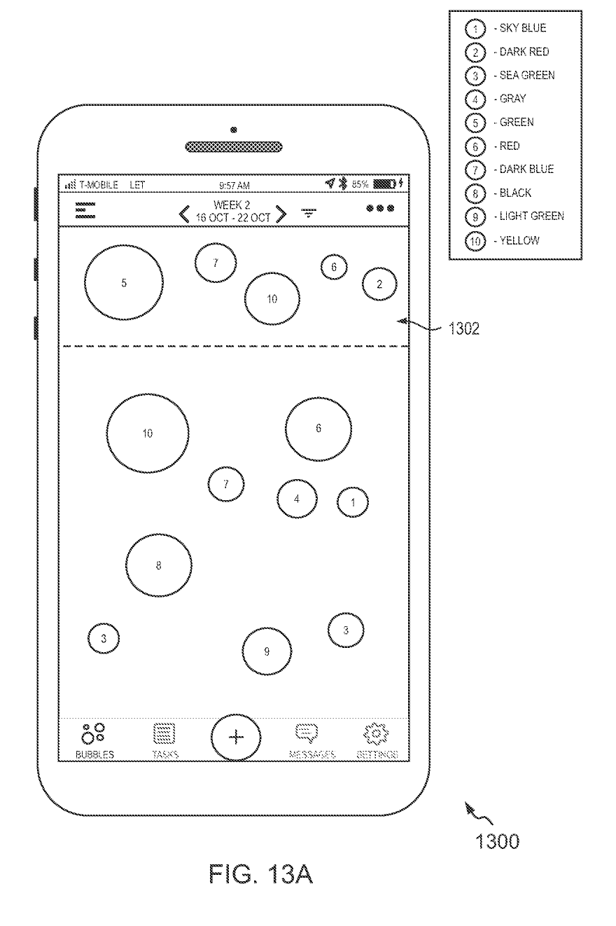

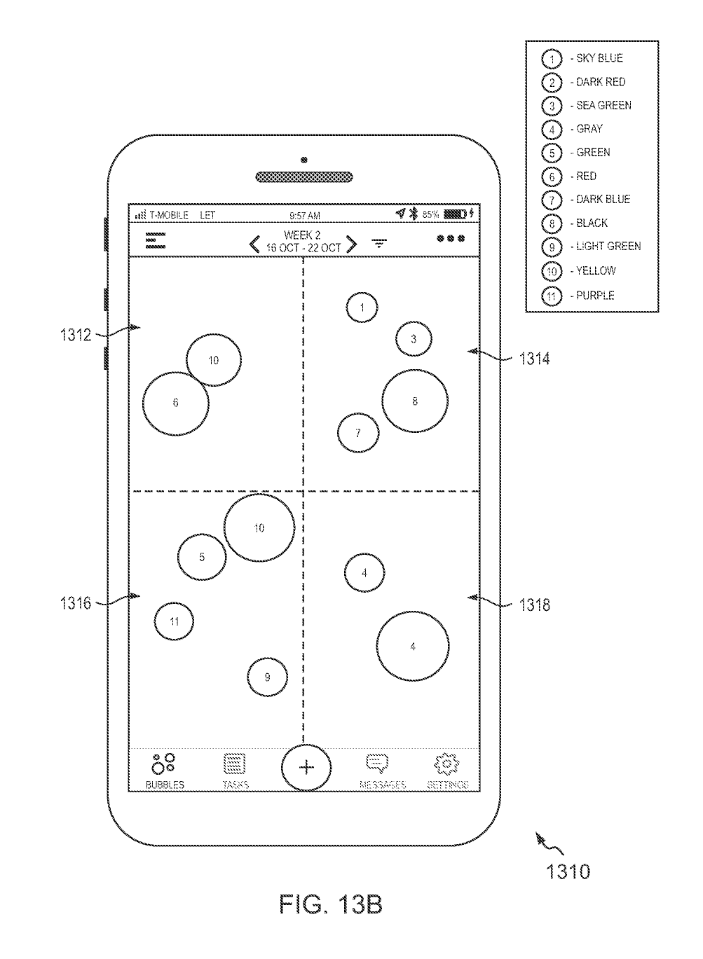

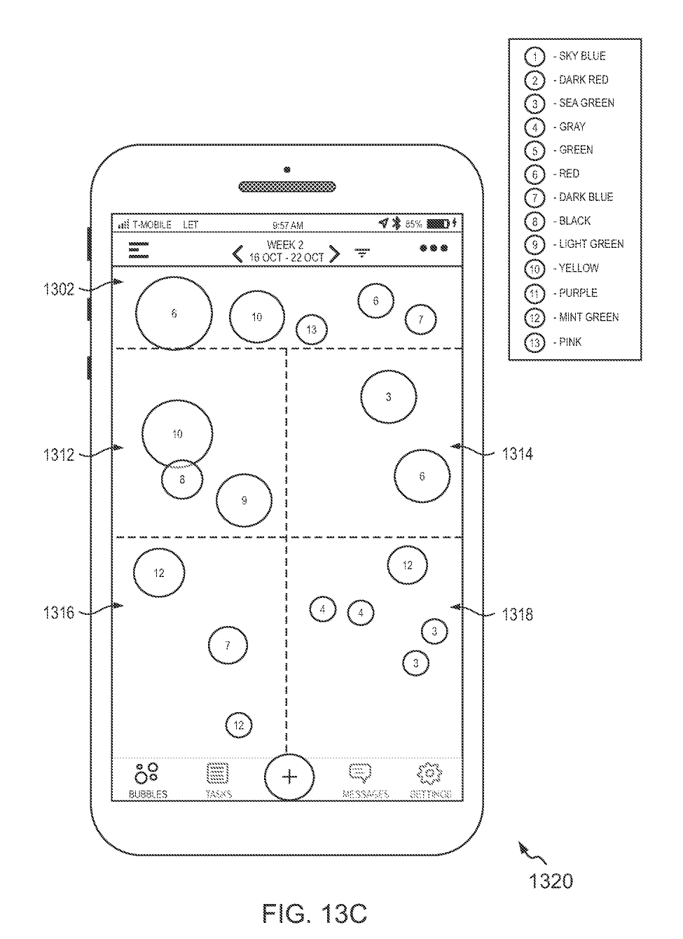

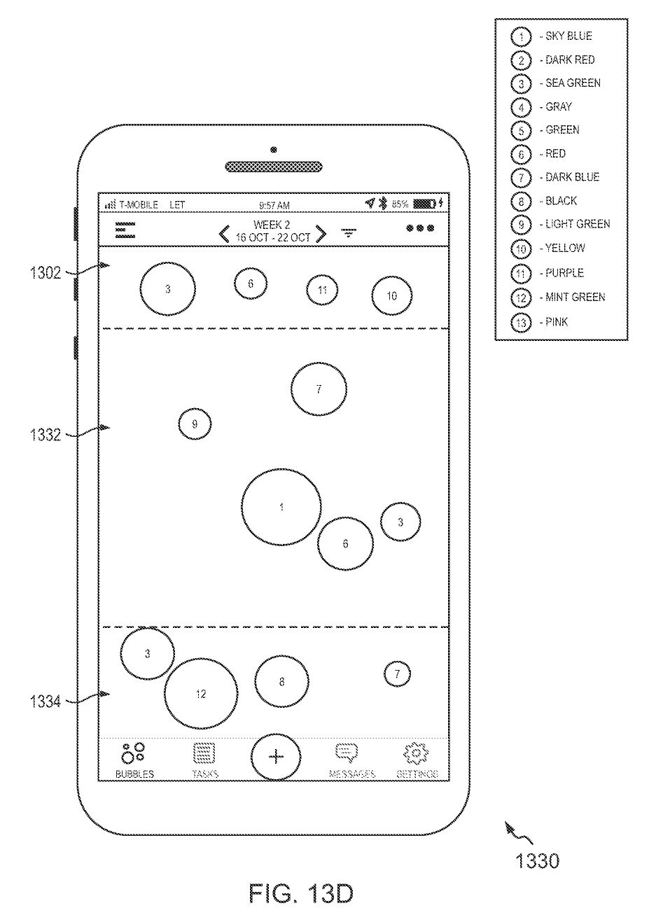

FIGS. 13A-13D illustrate user interfaces 1300, 1310, 1320 and 1330 displaying different arrangements of the tasks at the computing device 102 operated by the administrator 106. The different arrangements are also displayed at computing devices (not shown) of the users (employees or team members) associated with the tasks and with whom the tasks have been shared by the administrator 106. The user interface 1300 displays an arrangement in which a user can utilize a portion of bubbles to align tasks that he/she is currently planning to work on. The user interface 1300 shows a field 1302 tagged as “Do it now!”. For example, tasks numbered as “5”, “7”, “10”, “6” and “2” may be included in the field 1302 and should be done immediately. There can be a few other tasks in the field 1302 that started simultaneously or have been started by team of employees who are responsible for each task.

The user interface 1300 may further display other example arrangements, such as displaying a master list and daily task list, displaying 2 large tasks and 3 small tasks for each day, displaying the most important tasks for the day or displaying at least 3 high priority tasks to focus on during a day, etc.

The user interface 1310 displays an arrangement in which tasks can be viewed in a matrix layout based on techniques such as “Stephen Covey time management method” as set forth in a book titled “First Things First”, written by Stephen Covey, A. Roger Merrilland Rebecca R. Merrill, published by Simon and Schuster, in year 1994. (ISBN 0-684-80203-1). As seen in FIG. 13B, a user can define fields/spaces (1312, 1314, 1316 and 1318) in the user interface 1310 to divide tasks into four categories defined by the fields/spaces. The field 1312 may include tasks that are important but not urgent, the field 1314 may include tasks that are important and urgent, the field 1316 may include tasks that are neither important nor urgent and the field 1318 may include tasks that are not important but urgent. For example, tasks numbered as “6” and “10” may be included in the field 1312, tasks numbered as “1”, “3”, “7” and “8” may be included in the field 1314, tasks numbered as “5”, “9”, 10” and “11” may be included in the field 1316 and tasks numbered as “4” may be included in the field 1318.

The user interface 1320 displays an arrangement of tasks which is a combination of the arrangement shown in the user interface 1300 and the user interface 1310. A portion of the tasks (bubbles) may be displayed in the field 1302 tagged as “Do it now!”. Another portion of the tasks may be divided into four categories defined by the fields/spaces 1312, 1314, 1316 and 1318.

The user interface 1330 of FIG. 13D displays an arrangement of tasks by dividing tasks into three categories defined by the three fields 1302 (as shown in FIGS. 13A and 13C), 1332 and 1334. The field 1332 includes tasks that are being staged for action or are to be moved to the field 1302 (“Do it now!”). For example, tasks numbered as “1”, “3”, “6”, “7” and “9” may be included in the field 1332. The field 1334 includes tasks that require processing into other fields or to be moved for other action. The field 1334 is tagged as “Review for action”. For example, tasks numbered as “3”, “7”, “8” and “12” may be included in the field 1334. The final value 1108 of all tasks for the week 14 Nov. 2017 to 25 Nov. 2017 may be displayed (not shown) at the user interfaces 1300, 1310, 1320 and 1330. Further, the task names, the effort point and the contextual value of each task for the week 14 Nov. 2017 to 25 Nov. 2017 may be displayed next to the bubbles (not shown) at the user interfaces 1300, 1310, 1320 and 1330.

The tasks can be arranged or organized by the administrator 106 and/or the users (employees or team members) associated with the tasks in the application at their respective computing devices in any suitable way that creates a specific visual pattern comprehensible to the administrator 106 or to the user, thereby prioritizing the one or more tasks. The layouts of the tasks displayed in the user interfaces 1210, 1220, 1230, 1240 1250, 1300, 1310, 1320 and 1330 may be arranged by the administrator 106 or any user by dragging and dropping tasks between time frames between columns and rows, etc.

The application may display status of the one or more tasks. The application further facilitates a filter for filtering tasks at least based on priority, status, responsibility areas, effort points, time frames, users associated with the tasks and workload. The application further displays the tasks with the filters applied.

In one embodiment, the application can also be applied as a personal task management system. In such a scenario, a user can plan his/her tasks in weekly budgets and manage them in the same way as described above. Effort Points are used which are indirectly related in time involved into task solution, area of responsibility and velocity point and density point as a boundary of weekly productivity. A computing device of the user (e.g. computing device 102) receives a task input from the user. The computing device receives a time frame for the task, the time frame including a start date and an end date for the task. A processor of the computing device allocates one or more tasks within the time frame. The server 102 further receives an effort point input, the effort point input indicating effort points associated with the task and displays the task in form of objects of a plurality of colors and sizes at least based on the effort points.

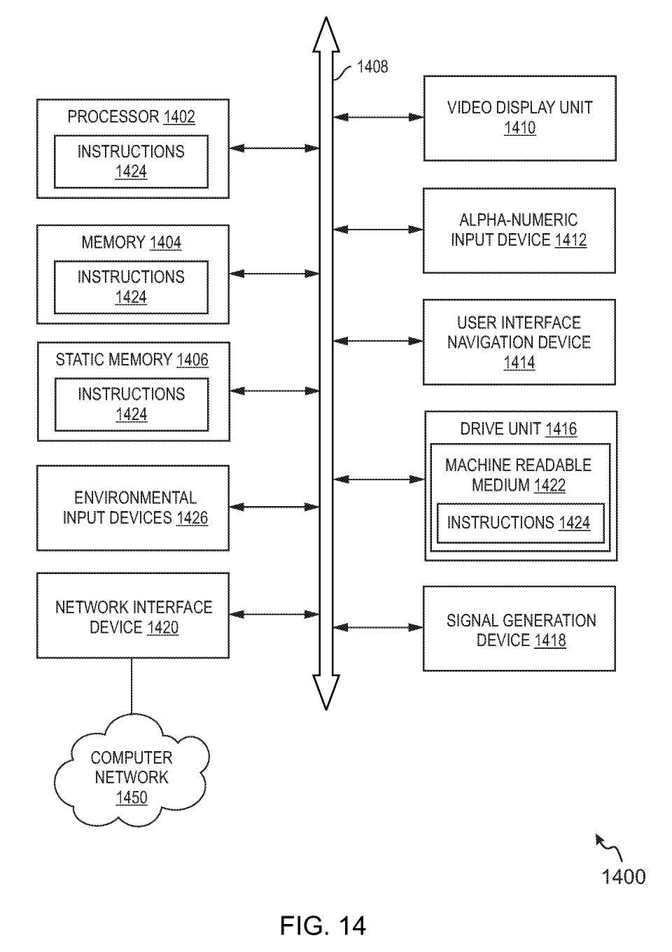

FIG. 14 is a simplified block diagram of a system 1400 which may be an example of the computing device 102 or a device associated with an employee or team member. The system 1400 may also be an example of the server 110. Instructions within the system 1400, causes the system 1400 to perform any one or more of the methods discussed herein. In a networked deployment, the system 1400 may operate in the capacity of a server or a client device in a server-client network environment, or as a peer machine in a peer-to-peer (or distributed) network environment. The system 1400 may be any device capable of executing instructions (sequential or otherwise) that specify actions to be taken by the system 1400. Further, while only a single device is illustrated, the term “device” shall also be taken to include any collection of devices that individually or jointly execute a set (or multiple sets) of instructions to perform any one or more of the methods discussed herein.

The system 1400 includes a processor 1402 (e.g., a central processing unit (CPU), a graphics processing unit (GPU), or both), a main memory 1404, and a static memory 1406, which communicate with each other via a bus 1408. The system 1400 may further include a video display unit 1410 (e.g., a liquid crystal display (LCD) or a cathode ray tube (CRT)). The system 1400 also includes an alphanumeric input device 1412 (e.g., a keyboard), a user interface (UI) navigation device 1414 (e.g., a mouse), a disk drive unit 1416, a signal generation device 1418 (e.g., a speaker) and a network interface device 1420. The system 1400 may also include a environmental input device 1426 that may provide a number of inputs describing the environment in which the system 1400 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

The disk drive unit 1416 includes a machine-readable medium 1422 storing one or more sets of data structures and instructions 1424 (e.g., software) embodying or utilized by any one or more of the methodologies or functions described herein. The instructions may be computer executable codes of the application. The instructions 1424 may also reside, completely or at least partially, within the main memory 1404 and/or within the processor 1402 during execution thereof by the system 1400, the main memory 1404 and the processor 1402 also constituting machine-readable media. While the machine-readable medium 1422 is shown in an example embodiment to be a single medium, the term “machine-readable medium” may include a single medium or multiple media (e.g., a centralized or distributed database, and/or associated caches and servers) that store the one or more instructions 1424 or data structures. The term “non-transitory machine-readable medium” shall also be taken to include any tangible medium that is capable of storing, encoding, or carrying instructions for execution by the machine and that cause the machine to perform anyone or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 1424 may further be transmitted or received over a computer network 1450 (such as computer network 108) using a transmission medium. The instructions 1424 may be transmitted using the network interface device 1420 and any one of a number of well-known transfer protocols (e.g., HTTP).Examples of communication networks include a local area network (LAN), a wide area network(WAN), the Internet, mobile telephone networks, Plain Old Telephone Service (POTS)networks, and wireless data networks (e.g., Wifi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from Math Works), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise JavaBeans. Much functionality described herein can be implemented in computer software, computer hardware, or a combination. Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 902.11 including its sub standards a, b, e, g, h, i, n, et al.). In one example, signals from the device 1400 can be transferred, at least in part, wirelessly to components or other computers.

Without in any way limiting the scope, interpretation, or application of the claims appearing below, a technical effect of one or more of the example embodiments disclosed herein is to provide computer implemented methods and systems for effectively managing tasks. The system provides a simple solution in form of a digital platform/application. The application enables creating patterns that motivates user to complete the tasks. The solution provides a fast and easy delivery estimate for related tasks thereby saving time with dynamic planning of workflow. The solution further provides full transparency of the workload among all users. Additionally, the application facilitates easy and understandable visualization of workload and enables dynamic visual task management board with drag and drop of the bubbles. The solution ensures reliable issue tracking and an enhanced ability to plan “on a fly” or “plan by air”.

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 14. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application \or implementation without departing from the spirit or scope of the claims.

What is claimed is:

1. A computer-implemented method for managing tasks, the method comprising:
receiving a task input, by a processor, the task input comprising a task from among a plurality of tasks, the task input received from an administrator of the plurality of tasks;
receiving a time frame for the task, by the processor, the time frame comprising a start time and an end time;
receiving a responsibility area associated with the task, by the processor, the responsibility area selected from one or more responsibility areas of an organization;
receiving an effort point, by the processor, the effort point associated with an effort needed to complete the task; and
facilitating display of the task in a digital platform, the task displayed with one or more representations of the responsibility area, the time frame and the effort, the one or more representations at least being a color, a shape, and size of the shape.

2. The method as claimed in claim 1, further comprising:
receiving, by the processor, a resource limit input for each of the plurality of tasks, the resource limit input defining resources required for completion of each of the plurality of tasks; and
facilitating display of a velocity point based on the resource limit input in the digital platform.

3. The method as claimed in claim 1, further comprising facilitating display of a density point for each of the plurality of tasks, wherein the density point is a collective measure of effort points associated with each of the plurality of tasks.

4. The method as claimed in claim 1, wherein receiving the time frame for the task, further comprises allocating one or more tasks received in one or more task inputs within the time frame.

5. The method as claimed in claim 4, further comprising, receiving a contextual value for each of the one or more tasks.

6. The method as claimed in claim 5, further comprising:
calculating, by the processor, a performance value of each of the one or more tasks based on corresponding effort point and corresponding contextual value; and
determining a final value of the one or more tasks allocated within the time frame, wherein the final value is addition of performance values of the one or more tasks within the time frame.

7. The method as claimed in claim 1, wherein facilitating display of the task comprises facilitating display of the task at a device of the administrator and at devices associated with users related to the responsibility area associated with the task.

8. The method as claimed in claim 1, further comprising facilitating display of the plurality of tasks in the digital platform upon receipt of a plurality of task inputs comprising the plurality of tasks, wherein each task is arranged by a position and a layout in the digital platform based on a priority of tasks.

9. The method as claimed in claim 8, further comprising enabling changing of corresponding time frames of the plurality of tasks.

10. The method as claimed in claim 1, wherein receiving the effort point comprises facilitating a slider in the digital platform comprising a minimum value and a maximum value, wherein a movement of the slider between the minimum and the maximum values defines the effort point for the task.

11. The method as claimed in claim 1, further comprising displaying a status of the task in the digital platform.

12. The method as claimed in claim 1, further comprising facilitating a filter to display one or more tasks received by the processor based at least on priority, status, responsibility areas, effort points, time frames, users associated with the one or more tasks and workload.

13. The method as claimed in claim 1, further comprising receiving a definition of the responsibility area, and facilitating display of the task further comprises displaying the definition in the digital platform.

14. The method as claimed in claim 1, wherein at least one of the task input, the time frame, the responsibility area, the effort point is in form a text input.

15. A system comprising:
a memory storing instructions; and
a processor configured to execute the stored instructions to cause the system to at least perform:
receiving a task input comprising a task from among a plurality of tasks, the task input received from an administrator of the plurality of tasks;
receiving a time frame for the task, the time frame comprising a start time and an end time;
receiving a responsibility area associated with the task, the responsibility area selected from one or more responsibility areas of an organization;
receiving an effort point for the task, the effort point associated with an effort needed to complete the task; and
facilitating display of the task in a digital platform, the task displayed with one or more representations of the responsibility area, the time frame and the effort, the one or more representations at least being a color, a shape, and size of the shape.

16. The system as claimed in claim 15, wherein the system is further caused to:
receive a resource limit input for each of the plurality of tasks, the resource limit input defining resources required for completion of each of the plurality of tasks; and
facilitate display of a velocity point based on the resource limit input in the digital platform.

17. The system as claimed in claim 15, wherein the system is further caused to facilitate display of a density point for each of the plurality of tasks, wherein the density point is a collective measure of effort points associated with each of the plurality of tasks.

18. The system as claimed in claim 15, wherein the system is further caused to facilitate display of the plurality of tasks in the digital platform upon receipt of a plurality of task inputs comprising the plurality of tasks, wherein each task is arranged by a position and a layout in the digital platform based on a priority of tasks.

19. The system as claimed in claim 15, wherein the system is further caused to:
receive a resource limit input for one or more tasks, the resource limit input defining resources required for the one or more tasks allocated into the time frame; and
facilitate display of a velocity point based on the resource limit input.

20. The system as claimed in claim 15, wherein the system is further caused to display a density point, wherein the density point is a collective measure of effort points associated with the one or more tasks allocated into the time frame.

21. The system as claimed in claim 15, wherein the system is further caused to facilitate a filter to display one or more tasks received by the system based at least on priority, status, responsibility areas, effort points, time frames, users associated with the tasks and workload.

22. A computer-implemented method for managing tasks, the method comprising:
receiving a task input, by a processor, the task input comprising a task from among a plurality of tasks, the task input received from an administrator of the plurality of tasks;
receiving a time frame for the task, by the processor, the time frame comprising a start time and an end time;
receiving a responsibility area associated with the task, by the processor, the responsibility area selected from one or more responsibility areas of an organization;
receiving an effort point, by the processor, the effort point associated with an effort needed to complete the task; and
facilitating display of the task in a digital platform, wherein responsibility area is displayed in a bubble of a color corresponding to the responsibility area, wherein a size of the bubble is proportional to the effort point, and wherein the one or more responsibility areas are associated with one or more corresponding colors.

23. The method as claimed in claim 22, further comprising facilitating display of the plurality of tasks in the digital platform upon receipt of a plurality of task inputs comprising the plurality of tasks, wherein each task is arranged by a position and a layout in the digital platform based on a priority of tasks.
